(19) United States
(12) Patent Application Publication
(10) Pub. No.: US 2014/0357479 A1
(43) Pub. Date: Dec. 4, 2014

(54) Variations for Synthesizing Zero Platinum Group Metal Catalyst Systems

(71) Applicants: Zahra Nazarpoor, Camarillo, CA (US); Stephen J. Golden, Santa Barbara, CA (US)

(72) Inventors: Zahra Nazarpoor, Camarillo, CA (US); Stephen J. Golden, Santa Barbara, CA (US)

(73) Assignee: CDTI, Ventura, CA (US)

(21) Appl. No.: 13/904,246

(22) Filed: May 29, 2013

(51) Int. Cl. B01J 23/889

(52) U.S. Cl. CPC B01J 23/8892
USPC 502/302; 502/324

(57) ABSTRACT

Variations of synthesis methods for Zero Platinum Group Metal (ZPGM) catalyst systems are disclosed herein. The methodologies of influence of synthesis methods on Cu—Mn catalyst systems which may include a variation of carrier metal oxides are disclosed. The XRD characterization and activity measurements of a series of stoichiometric and non-stoichiometric Cu—Mn spinels with different support oxide are discussed.

### CROSS-REFERENCE TO RELATED APPLICATIONS

N/A

### BACKGROUND

1. Technical Field

This disclosure relates generally to catalyst systems, and, more particularly, to variations resulting from synthesizing materials used in Zero Platinum Group Metal (ZPGM) catalyst systems.

2. Background Information

Regulatory standards for acceptable emissions may be continuously revised in response to human health issues and air-quality concerns. Said strict-compliance regulatory standards may have been adopted worldwide to control emissions of nitrogen oxides nitrogen (NOₓ), particulate matters (PM), carbon monoxide (CO), and carbon dioxide (CO₂) from various sources, such as automobiles, utility plants, and processing and manufacturing plants amongst others.

Catalysts to control toxic emissions may have a composite structure consisting of transition metal nano-particles or ions dispersed and supported on the surface of a support material. Said support materials may be either micro-particles with a very large specific surface area or a highly porous matrix. A requirement for the materials which may be used is that the catalyst may exhibit a very high level of heat resistance and be capable of ensuring stability and reliability in long-term service.

Catalyst systems may be manufactured using platinum group metals (PGM) which may be characterized by a small market circulation volume, constant fluctuations in price, and constant risk to stable supply, variables that drive up their cost. These facts may be conducive to the realization of a PGM-free catalyst.

For the foregoing reasons there may be a need to provide material compositions for PGM-free catalyst systems which may be able to perform in a variety of environments. Said catalyst systems may vary in a number of ways using synergistic effects derived from tools of catalyst design and synthesis methods.

### SUMMARY

The present disclosure may provide a methodology for synthesis of Cu—Mn ZPGM catalysts using different synthesis methods.

Compositions of ZPGM catalyst systems may include any suitable combination of a substrate, a washcoat, an overcoat or impregnation component, which includes copper (Cu) and manganese (Mn) catalysts in combinations that are free of platinum group metals to form mixed phase of metal oxide and spinel catalysts.

The desirable mixed phase systems may be affected by synthesis methods and type of carrier metal oxides.

Synthesis methods that may be used to form stoichiometric and non-stoichiometric Cu—Mn spinel include co-precipitation, impregnation, co-milling, templating, colloidal, organometallic and sol-gel methods, or any other suitable methods known in the art. Subsequently, corresponding phase analyses may be determined by XRD measurement. Implemented synthesis methods for ZPGM Cu—Mn catalyst is compared according to the results from the effects of the synthesis method, type of supports, and type of Cu—Mn spinel and crystallite structure of mixed oxide phase.

ZPGM Cu—Mn spinel catalyst maybe coated on a substrate by impregnation of the stabilized Cu—Mn spinel solution on a substrate previously washcoated, or by co-milling of Cu—Mn spinel solution with carrier material oxides and deposited on substrate. After deposition a heat treatment may be required.

Numerous objects and advantages of the present disclosure may be apparent from the detailed description that follows and the drawings which illustrate the embodiments of the present disclosure, and which are incorporated herein by reference.

### BRIEF DESCRIPTION OF THE DRAWINGS

Non-limiting embodiments of the present disclosure are described by way of example with reference to the accompanying figures which are schematic and are not intended to be drawn to scale. Unless indicated as representing the background art, the figures represent aspects of the disclosure.

FIG. 1 shows a ZPGM catalyst system configuration, according to an embodiment.

FIG. 2 depicts a flowchart of templating method used to prepare ZPGM Cu—Mn catalyst system, according to an embodiment.

FIG. 3 shows XRD analysis of a fresh and aged stoichiometric spinel of Cu_{1.0}Mn_{2.0}O₄, according to an embodiment.

FIG. 4 shows XRD analysis of a fresh stoichiometric spinel of Cu_{1.0}Mn_{2.0}O₄ after reaction, according to an embodiment.

FIG. 5 shows XRD analysis of an aged stoichiometric spinel of Cu_{1.0}Mn₂₀O₄, according to an embodiment.

FIG. 6 illustrates crystallite size comparison of fresh Cu—Mn spinel catalysts, according to an embodiment.

FIG. 7 illustrates CO light-off curves of variation of synthesis method with zirconium-niobium oxide support, according to an embodiment.

FIG. 8 illustrates NO light-off curves of variation of synthesis method with zirconium-niobium oxide support, according to an embodiment.

FIG. 9 illustrates CO light-off curves of variation of synthesis method with praseodymium doped zirconia support, according to an embodiment.

FIG. 10 illustrates NO light-off curves of variation of synthesis method with praseodymium doped zirconia support, according to an embodiment.

### DETAILED DESCRIPTION

In the following detailed description, reference is made to the accompanying drawings, which form a part hereof. In the drawings, which are not necessarily to scale or to proportion, similar symbols typically identify similar components, unless context dictates otherwise with emphasis being placed upon illustrating the principles of the invention. The illustrative embodiments described in the detailed description, drawings and claims, are not meant to be limiting. Other embodiments may be used and/or other changes may be made without departing from the spirit or scope of present disclosure.

### Definitions

As used here, the following terms have the following definitions:

“R value” may refer to the number obtained by dividing the reducing potential by the oxidizing potential.

“Rich exhaust” may refer to exhaust with an R value above 1.

“Conversion” may refer to the chemical alteration of at least one material into one or more other materials.

“Catalyst” may refer to one or more materials that may be of use in the conversion of one or more other materials.

“Carrier material oxide (CMO)” may refer to support materials used for providing a surface for at least one catalyst.

“Oxygen storage material (OSM)” may refer to a material able to take up oxygen from oxygen rich streams and able to release oxygen to oxygen deficient streams.

“Washcoat” may refer to at least one coating including at least one oxide solid that may be deposited on a substrate.

“Overcoat” may refer to at least one coating that may be deposited on at least one washcoat layer.

“Zero platinum group (ZPGM) catalyst” may refer to a catalyst completely or substantially free of platinum group metals.

“Synthesis method” may refer to an execution of chemical reactions to form a catalyst from different precursor materials.

### DESCRIPTION OF THE DRAWINGS

Catalyst System Configuration

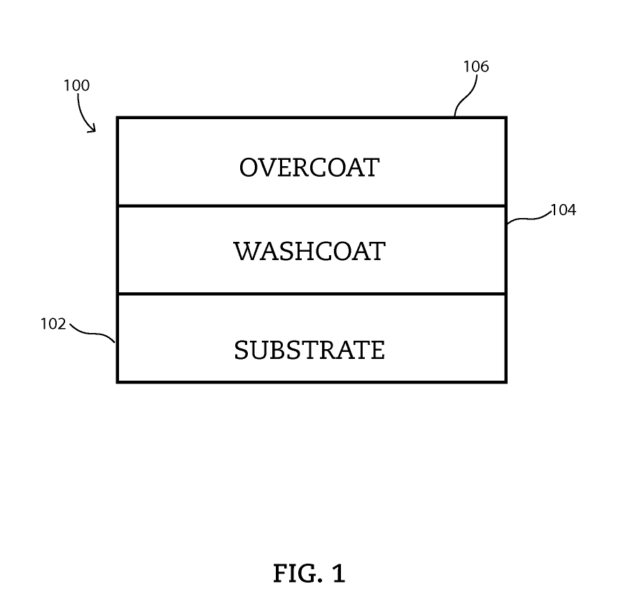

FIG. 1 depicts ZPGM Cu—Mn catalyst system 100 configuration of the present disclosure. As shown in FIG. 1, ZPGM Cu—Mn catalyst system 100 may include at least a substrate 102, a washcoat 104, and an overcoat 106, where washcoat 104 and overcoat 106 may include Cu—Mn spinel ZPGM catalyst.

In an embodiment of the present disclosure, substrate 102 materials may include a refractive material, a ceramic material, a honeycomb structure, a metallic material, a ceramic foam, a metallic foam, a reticulated foam, or suitable combinations, where substrate 102 may have a plurality of channels with suitable porosity. Porosity may vary according to the particular properties of substrate 102 materials. Additionally, the number of channels may vary depending upon substrate 102 used as is known in the art. The type and shape of a suitable substrate 102 would be apparent to one of ordinary skill in the art.

According to an embodiment of the present disclosure, either washcoat 104 or overcoat 106 may include Cu—Mn spinel compound as ZPGM transition metal catalyst. Additionally, washcoat 104 and overcoat 106 may include support oxides material referred to as carrier material oxides. Carrier material oxides may include aluminum oxide, doped aluminum oxide, spinel, delafossite, lyonsite, garnet, perovksite, pyrochlore, doped ceria, fluorite, zirconium oxide, doped zirconia, titanium oxide, tin oxide, silicon dioxide, zeolite, and mixtures thereof. In the present embodiment, washcoat 104 and overcoat 106 may include oxygen storage materials (OSM), such as cerium, zirconium, lanthanum, yttrium, lanthanides, actinides, and mixtures thereof, but the catalysts of the present disclosure may be found to function well as oxidation/reduction catalysts without an OSM.

Cu—Mn Spinel ZPGM Synthesis Methods

A variety of synthesis methods may be implemented according to principles in the present disclosure. Synthesis methods that may be used include but are not limited to co-precipitation, impregnation, co-milling, templating, colloidal, organometallic and sol-gel methods.

ZPGM Cu—Mn catalyst system 100 may be prepared by variety of synthesis methods, subsequently, corresponding phase analyses may be determined by XRD analysis. Implemented synthesis methods for ZPGM Cu—Mn catalyst system 100 may be compared according to catalysts prepared. Comparisons may be performed according to the results from the effects of the used synthesis method, type of supports, and type of spinel. XRD analyses and catalyst performance tests may be used to compare catalyst properties.

Preparation of a ZPGM Catalyst by Co-Milling Method

In order to prepare a ZPGM catalyst employing co-milling method, a catalyst and a carrier material oxide may be milled together. Co-milling process may begin with mixing washcoat 104 or overcoat 106 materials with water or any suitable organic solvent. Suitable organic solvents may include ethanol, diethyl ether, carbon tetrachloride, trichloroethylene, among others. Milling process in which washcoat 104 or overcoat 106 materials may be broken down into smaller particle sizes, may take about 10 minutes to about 10 hours, depending on the batch size, kind of material and particle size desired. The milling process may be achieved by employing any suitable mill such as vertical or horizontal mills. In order to measure exact particle size desired during the milling process, laser light diffraction equipment may be employed. After milling process, a catalyst aqueous slurry may be obtained. In order to enhance binding property washcoat 104 to substrate 102, aqueous slurry obtained in milling process may undergo adjusting rheology, in which, acid or base solutions or various salts or organic compounds may be added to the aqueous slurry. Some examples of compounds that can be used to adjust the rheology may include ammonium hydroxide, aluminum hydroxide, acetic acid, citric acid, tetraethyl ammonium hydroxide, other tetralkyl ammonium salts, ammonium acetate, ammonium citrate, and other suitable compounds. The milled catalyst and carrier material oxide may be deposited on substrate 102 in the form of washcoat 104 or overcoat 106 and then treated separately. Washcoat 104 and overcoat 106 may be treated for about 2 hours to about 6 hours at a temperature within a range of about of 300° C. to about 700° C., preferably 550C.

Preparation of a ZPGM Catalyst by Impregnation Method

A ZPGM catalyst system includes substrate 102 and washcoat 104 and may include an impregnation component. Impregnation component includes the Cu—Mn ZPGM catalysts. Washcoat 104 may be deposited on substrate 102 and include carrier metal oxide and may include oxygen storage material. Washcoat 104 does not contain ZPGM catalyst. Washcoat 104 may prepared by any suitable chemical methods known in the art and treated after deposition on substrate 102. The treating may be done at a temperature within a range of about 300° C. and about 700° C. and may last from about 2 to about 6 hours. After washcoat 104 and substrate 102 are treated, washcoat 104 may be cooled to about room temperature. After washcoat 104 and substrate 102 are cooled, washcoat 104 may be impregnated with Cu—Mn impregnation solution. The impregnation component may include copper and manganese salts being dissolved in water and impregnated on washcoat 104. Following the impregnation step, washcoat 104 with the impregnation components may be treated. For example, treatment may be for about 4 hours at a temperature of about 550° C. Substrate 102, washcoat 104, and the impregnation components may be heat treated to form the catalyst composition after washcoat 104 and the impregnation components may be added to substrate 102.

Preparation of a ZPGM Catalyst by Sol-Gel Method

Preparation of a ZPGM catalyst by sol-gel synthesis method may include hydrolysis, condensation-gelation, aging and drying. Preparation starts by hydrolysis of stoichiometric amount of copper and manganese precursors in aqueous solution. Typical Cu and Mn salt precursors that may be used include chlorides, nitrates, and acetates, as well as any other suitable precursors. In this synthesis method, the solution may gradually evolve into forming a gel-like system by adding the metal aqueous solutions to stabilizing component such as aqueous solution of ethylene glycol, citric acid, or glycolic acid. The pH and temperature need to be controlled in this synthesis method. Aging of this colloidal solution may be performed under continuous stirring at basic pH and temperature at the range of 60° C. to 90° C. to form the gel. The pH may be kept at range of 8 to 9 by adding ammonium hydroxide. Aging will last between 8 to 20 hours and remaining liquid may be removed during this step. Drying is performed at temperature between 100° C. to 120° C. overnight. Dried gel undergoes calcination treatment which may be for about 4 hours at a temperature of about 550° C.

Preparation of ZPGM Cu—Mn Catalysts with Co—Precipitation Synthesis Method

The preparation may begin by mixing the appropriate amount of Mn nitrate solution and Cu nitrate solution, where the suitable copper loadings may include loadings in a range of 10 to 20 percent by weight and suitable manganese loadings may include loadings in a range of 10 to 30 percent by weight. Subsequently, the Cu—Mn solution is mixed with slurry of carrier material oxide support. Co-precipitation method may be created by addition of appropriate amount of one or more of NaOH solution, Na₂CO₃ solution, and ammonium hydroxide (NH₄OH) solution. The pH of above slurry may be adjusted at the range of 7-9 and the slurry may be aged for a period of time of about 12 to 24 hours under continues stirring. This precipitation may be formed over a slurry including at least one suitable carrier material oxide, where the slurry may include any number of additional suitable carrier material oxides, and may include one or more suitable Oxygen Storage Materials. After precipitation, the metal oxide slurry may then undergo filtering and washing, where the resulting material may be dried and may later be calcined at any suitable temperature of about 300° C. to about 600° C., preferably about 500° C. for about 5 hours.

Metal salt solutions suitable for use in the co-precipitation method described above may include solutions of copper nitrate (CuNO₃) or copper acetate and manganese nitrate (MnNO₃) or manganese acetate in any suitable solvent.

Preparation of ZPGM Cu—Mn Catalysts with Templating Synthesis Method

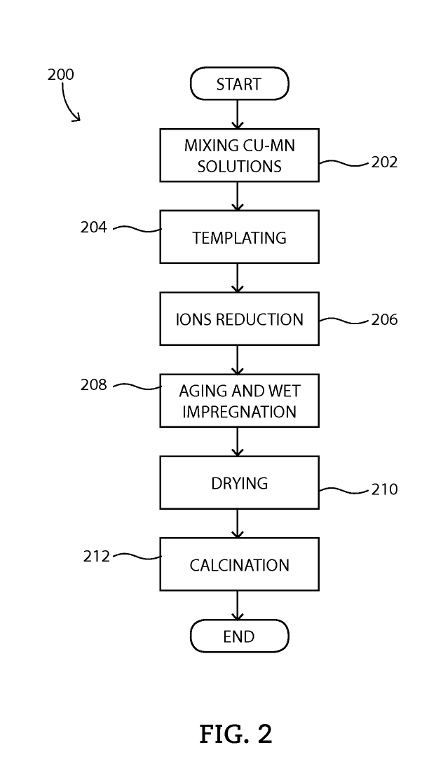

FIG. 2 depicts a flowchart of templating method 200 used to prepare ZPGM Cu—Mn catalyst system 100, according to an embodiment. The preparation may begin by mixing step 202 the appropriate amount of Mn nitrate solution and Cu nitrate solution. Other copper and manganese precursors such as acetate may also be used. The Cu/(Cu+Mn) molar ratio may vary from 0.1 to 0.9 which results in stoichiometric and non-stoichiometric Cu—Mn spinels. For example, a molar ratio of 0.33 corresponds to stoichiometric Cu_{1.0}Mn_{2.0}O₄ and a molar ratio of 0.2 corresponds to non-stoichiometric Cu_{0.6}Mn_{2.4}O₄. Subsequently, in templating step 204, above solution is stabilized by a templating agent such as polyethylene glycol, polyvinyl alcohol, polyacrylic acid, poly-siloxane, oligosaccharides, poly(4-vinylpyridine), poly(N,Ndialkylcarbodiimide), hyper-branched aromatic polyamides and other suitable polymers. In present disclosure, poly(N-vinyl-2pyrrolidone)(PVP) is used as templating agent with a weight ratio of PVP to total weight of metal in the range of 0.5:1 to 2:1, preferably 1:1. Templating step 204 is done at room temperature and may last 24 hours and processing may continue with ions reduction step 206, during which a NaBH₄ solution is added to reduce Cu—Mn ions to templated Cu—Mn particles. The NaBH₄ is added with a weight ratio of NaBH₄ to total metal in the range of 0.5:1 to 2:1, preferably 1:1. Subsequently, templated Cu—Mn particles may be aged at room temperature under continues stirring for 8 to 12 hours and then deposited on carrier metal oxide. Deposition on carrier metal oxide may be done as impregnation step 208 or any other deposition method known in the art, followed by drying step 210 and calcination step 212. The templating agent component is decomposed at temperature below 550° C. for example 96% of PVP component may decompose up to 500° C. Carrier metal oxides may include cerium oxides, aluminum oxides, titanium oxides, doped aluminum oxides, doped ceria, zirconium oxides, doped zirconia, tin oxides, silicon dioxides, zeolite, and combinations thereof. In the present disclosure, carrier metal oxide for supported stoichiometric and non-stoichiometric spinels may include ZrO₂—Nb₂O₅ and ZrO₂—Pr₆O₁₁. Catalysts containing Nb and Zr may promote the chemisorption of hydrocarbon by an acidic attack on the hydrocarbon double bond. In addition, catalysts containing Nb and Zr may exhibit resistance to SO₂ poisoning and may display enhanced oxidative properties and high permanent Broønsted acidity.

In case of coating of ZPGM Cu—Mn spinel on substrate 102, the stabilized Cu—Mn solution may be subsequently impregnated on washcoat 104, or co-milled with carrier material oxides and deposited on substrate 102. After deposition a heat treatment may be required. This treatment may be performed at about 300° C. to about 700° C. In some embodiments this treatment may be performed at about 550° C. The heat treatment may last from about 2 to about 6 hours.

The following examples are intended to illustrate the scope of the disclosure. It is to be understood that other procedures known to those skilled in the art may alternatively be used.

### Example #1

### Co—Precipitation Method for ZPGM Cu—Mn Spinel Catalyst Systems

Example #1 shows ZPGM Cu—Mn powder catalyst of the present disclosure which may be synthesized by co-precipitation method and may include precipitating of Cu—Mn stoichiometric spinels on one or more carrier material oxides.

A ZPGM Cu—Mn powder catalyst, referred as SM1-Type 1, is a stoichiometric Cu_{1.0}Mn_{2.0}O₄spinel, Cu—Mn molar ratio of 0.33, supported on ZrO₂—Nb₂O₅. The carrier material oxide contains ZrO₂ from 60 to 80 percent by weight, preferably 75 percent by weight and Nb₂O₅ from 20 to 40 percent by weight, preferably 25 percent by weight. A mixed phase of Cu—Mn spinel and CuO formed at fresh sample which undergoes calcination at 550° C. The Cu—Mn spinel phase is stable during aging at 900° C. The fresh SM1-Type1 catalyst may show a crystallite size of 11 nm and aged SM1-Type1 catalyst may show a crystallite size of 18 nm.

A ZPGM Cu—Mn powder catalyst, referred as SM1-Type 2, is a stoichiometric Cu_{1.0}Mn_{2.0}O₄spinel, Cu—Mn molar ratio of 0.33, supported on praseodymium doped zirconia (ZrO₂—Pr₆O₁₁). This carrier material oxide contains ZrO₂ from 80 to 95 percent by weight, preferably 90 percent by weight and Pr₆O₁₁ from 5 to 20 percent by weight, preferably 10 percent by weight. A mixed metal oxide phase of CuO and MnO with crystallite size of 8 nm formed at fresh samples which undergoes calcination at 550° C. The evidence of formation of Cu—Mn spinel phase observed after aging SM1-Type 2 at 900° C. The aged SM1-Type 2 may show formation of a mixed metal oxide phase of Cu—Mn spinel, CuO, and Mn₃O₄ with a crystallite size of 10 nm.

### Example #2

### Templating Method for Stoichiometric ZPGM Cu—Mn Spinel Catalyst Systems

Example #2 shows ZPGM Cu—Mn powder catalyst of the present disclosure which may be synthesized by templating method 200 using PVP as stabilizer component. Cu—Mn stoichiometric spinels supported on one or more carrier material oxides may be synthesized by templating method 200.

A ZPGM Cu—Mn powder catalyst, referred as SM2-Type 1, is a stoichiometric spinel of Cu_{1.0}Mn_{2.0}O₄, Cu—Mn molar ratio of 0.33, supported on ZrO₂—Nb₂O₅. The carrier material oxide contains ZrO₂ from 60 to 80 percent by weight, preferably 75 percent by weight and Nb₂O₅ from 20 to 40 percent by weight, preferably 25 percent by weight. A mixed phase of Cu—Mn spinel and CuO formed at fresh sample which undergoes calcination at 550° C. The Cu—Mn spinel phase is stable during aging at 900° C. The fresh SM2-Type1 catalyst may show a crystallite size of 9 nm and aged SM2-Type1 catalyst may show a crystallite size of 14 nm. SM2-Type1 catalyst may show improvement in particle size and therefore dispersion compare to SM1-Type1 catalyst because of type of synthesis method.

A ZPGM Cu—Mn powder catalyst, referred as SM2-Type 2, is a stoichiometric spinel of Cu_{1.0}Mn_{2.0}O₄, molar ratio of 0.33, supported on praseodymium doped zirconia (ZrO₂—Pr₆O₁₁). This carrier material oxide contains ZrO₂ from 80 to 95 percent by weight, preferably 90 percent by weight and Pr₆O₁₁ from 5 to 20 percent by weight, preferably 10 percent by weight. A Cu_{1.0}Mn_{2.0}O₄ phase with crystallite size of 7 nm formed at fresh sample which undergoes calcination at 550° C. SM2-Type 2 shows improvement in formation of spinel phase in fresh sample compare to SM1-Type 2 catalyst because of the type of synthesis method. The Cu—Mn spinel phase is stable during aging at 900° C. A mixed oxide phase of Cu—Mn spinel, CuO and Mn₃O₄ with crystallite size of 7 nm formed after aging SM2-Type 2 at 900° C. SM2-Type2 catalyst may show improvement in particle size and therefore dispersion compare to SM1-Type2 catalyst because of type of synthesis method.

### Example #3

### Templating Method for Non-Stoichiometric ZPGM Cu—Mn Spinel Catalyst Systems

Example #3 shows ZPGM Cu—Mn powder catalyst of the present disclosure which may be synthesized by templating method 200 using PVP as stabilizer component. Cu—Mn non-stoichiometric spinels supported on one or more carrier material oxides may be synthesized by templating method 200.

A ZPGM Cu—Mn powder catalyst, referred as SM3-Type 1, is a non-stoichiometric spinel of Cu_{0.6}Mn_{2.4}O₄, Cu—Mn molar ratio of 0.2, supported on ZrO₂—Nb₂O₅. The carrier material oxide contains ZrO₂ from 60 to 80 percent by weight, preferably 75 percent by weight and Nb₂O₅ from 20 to 40 percent by weight, preferably 25 percent by weight. A Cu_{0.6}Mn_{2.4}O₄ spinel phase formed at fresh sample which undergoes calcination at 550° C. The Cu—Mn spinel phase is stable during aging at 900° C. The fresh SM3-Type1 catalyst may show a crystallite size of 9 nm and aged SM3-Type1 catalyst may show a crystallite size of 14 nm.

A ZPGM Cu—Mn powder catalyst, referred as SM3-Type 2, is a non-stoichiometric spinel of Cu_{0.6}Mn_{2.4}O₄, Cu—Mn molar ratio of 0.2, supported on praseodymium doped zirconia (ZrO₂—Pr₆O₁₁). This carrier material oxide contains ZrO₂ from 80 to 95 percent by weight, preferably 90 percent by weight and Pr₆O₁₁ from 5 to 20 percent by weight, preferably 10 percent by weight. A Cu_{0.6}Mn_{2.4}O₄phase with crystallite size of 8 nm formed at fresh sample which undergoes calcination at 550° C. The Cu—Mn spinel phase is stable during aging at 900° C. A mixed oxide phase of Cu—Mn spinel, CuO and Mn₃O₄ with crystallite size of 9 nm formed after aging SM3-Type 2 at 900° C.

### Catalyst Characterization

XRD measurements, comparisons, and performance for ZPGM Cu—Mn catalyst systems 100 which may be prepared by co-precipitation method and templating method 200, according to various embodiments of present disclosure, as described in Example #1, Example #2 and Example #3 are disclosed.

The XRD analysis is conducted to determine the phase structure Cu—Mn materials and to determine the crystallite size of mixed phase. The XRD patterns are measured on a Rigaku® powder diffractometer (MiniFlex™) using Cu Ka radiation in the 2-theta range of 15-80° with a step size of 0.02° and a dwell time of 1 s. The tube voltage and current were set at 40 kV and 30 rnA, respectively. The resulting diffraction patterns are analyzed using the International Centre for Diffraction Data (ICDD) database and crystallite sizes may be calculated by means of the Scherrer equation as known in the art.

Catalyst activity of samples of stoichiometric Cu_{1.0}Mn_{2.0}O₄spinels and non-stoichiometric Cu_{0.6}Mn_{2.4}O₄spinels may depend on the chemical composition, type of Cu—Mn oxide phase, and degree of crystallinity. In the present disclosure, catalyst activity tests may be compared by light off curves under steady state condition. The gas composition is simulated under exhaust rich condition at an R-value of 1.224 and temperature increased from 100° C. to 600° C. with a rate of 20° C./min. Propylene (C₃H₆) is used as feed hydrocarbon.

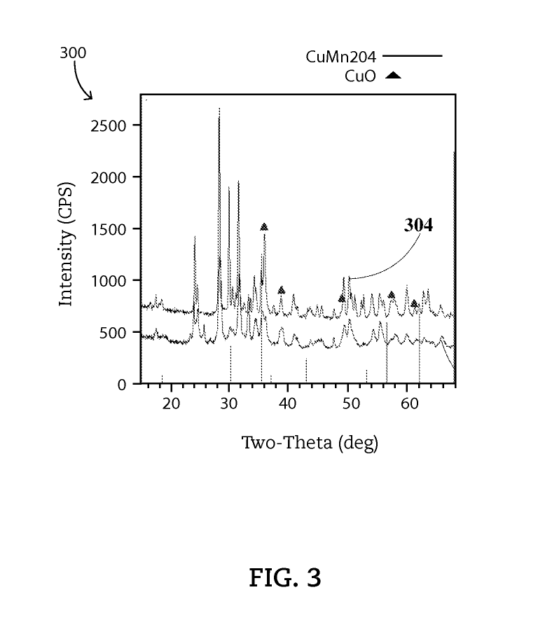

FIG. 3 shows XRD analysis 300 of fresh and aged stoichiometric Cu_{1.0}Mn_{2.0}O₄ spinel supported on ZrO₂—Nb₂O₅, as described in Example #2 and referred as SM2-Type 1. XRD spectrum 302 is for fresh sample of SM2-Type 1 and XRD spectrum 304 is for aged sample of SM2-Type 1. Solid lines correspond to Cu—Mn spinel phase and solid triangles refers CuO phase. The remaining diffraction peaks correspond to Nb₂O₅ and ZrO₂ phases from support. Comparison of these two spectra shows the stability of oxide phases during aging, however, the aged sample of SM2-Type 1, XRD spectrum 302, presents more crystallized structure after aging which is evidenced by sharper diffraction peaks.

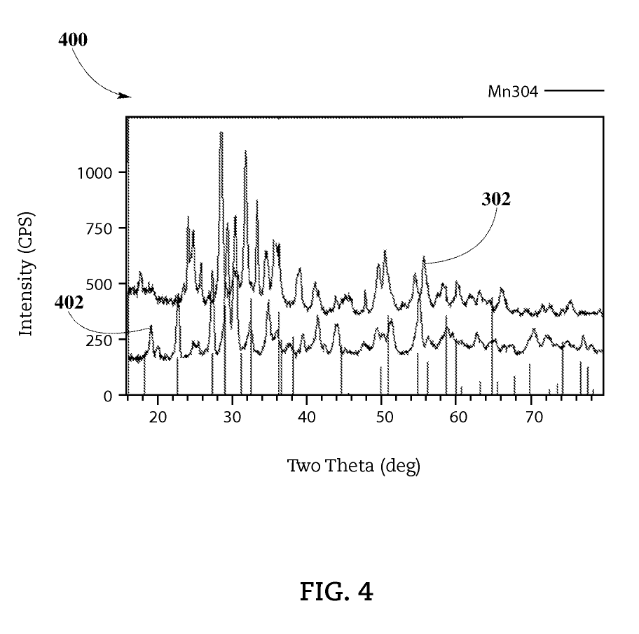

FIG. 4 shows XRD analysis 400, after reaction (RXN) of a fresh stoichiometric Cu_{1.0}Mn_{2.0}O₄ spinel, supported on ZrO₂—Nb₂O₅, as described in Example #2 and referred as SM2-Type 1. Fresh samples before and after reaction may be compared. As may be seen from XRD spectrum 302 and XRD spectrum 402, similar pattern may be observed after RXN, which may mean that the Cu—Mn spinel phase may not change during RXN. However, new manganese oxide phase may form during reaction under rich condition. The solid line in FIG. 4 corresponds to Mn₃O₄ phase which only observed after RXN.

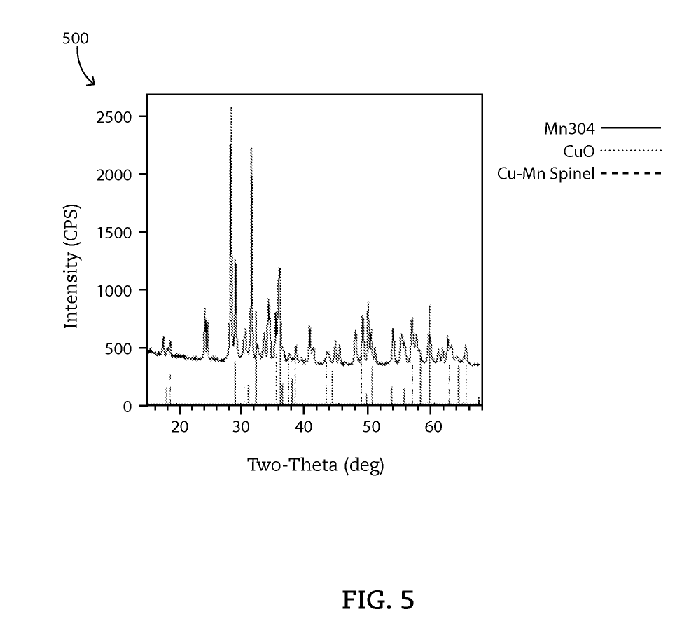

FIG. 5 shows XRD analysis 500 of an aged stoichiometric Cu_{1.0}Mn_{2.0}O₄ spinel, supported on ZrO₂-Pr₆O₁₁, as described in Example #2 and referred as SM2-Type 2. XRD analysis 500 of SM2-Type 2 shows formation of a mixed phase of Cu—Mn spinel (dot dash line), CuO phase (dash line) and Mn₃O₄ (solid line). The remaining diffraction peaks corresponds to ZrO₂ from support.

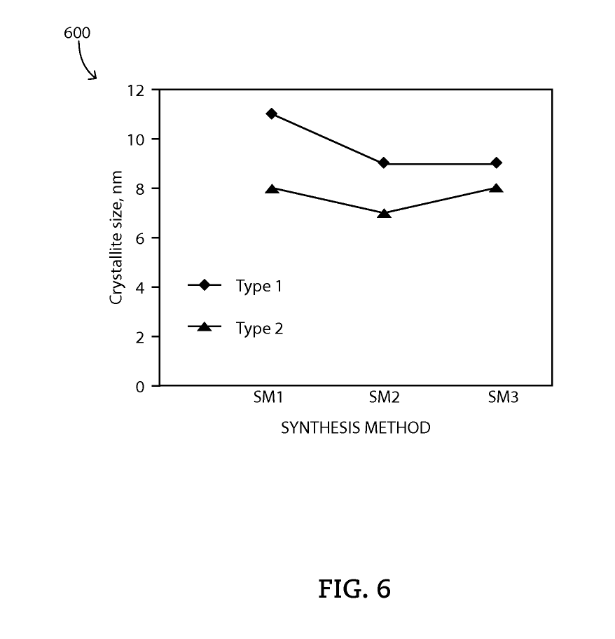

FIG. 6 illustrates crystallite size comparison 600 graphs of fresh Cu—Mn spinel catalysts explained in Example #1, Example #2 and Example #3. The crystallite size obtained by XRD measurements. The graphs compare the influence of synthetic method and choose of carrier metal oxide on crystallite size. SM1, SM2 and SM3 compare the synthesis method of co-precipitation of stoichiometric spinel, templating of stoichiometric spinel, and templating of non-stoichiometric spinel, respectively. Type 1 and Type 2 compare ZrO₂—Nb₂O₅ and ZrO₂—Pr₆O₁₁ metal oxide support, respectively. In general, templating method 200 leads to smaller crystallite size and therefore better metal dispersion. In addition, support effect shows decreasing of Cu—Mn crystallite size on ZrO₂—Pr₆O₁₁ compared to ZrO₂—Nb₂O₅.

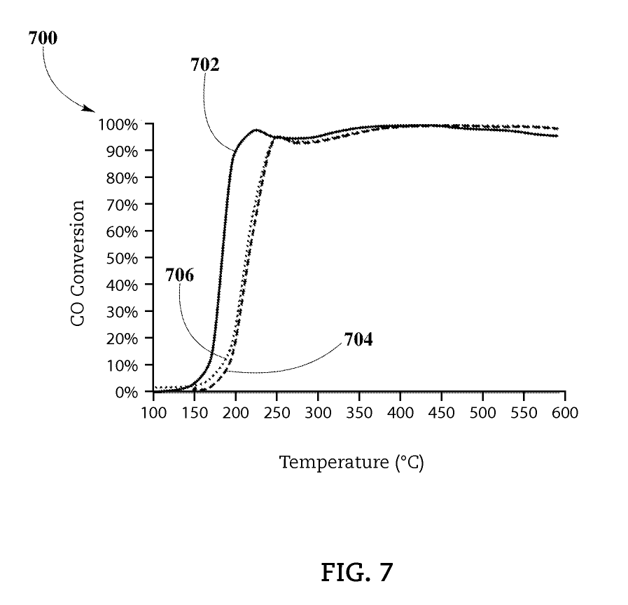

FIG. 7 illustrates CO light-off 700 of Cu—Mn ZPGM powder catalysts prepared by different synthesis methods on ZrO₂—Nb₂O₅ support. CO light-off curve 702 shows CO conversion for a fresh stoichiometric Cu—Mn spinel of Example #1 prepared by co-precipitation method, SM1-Type 1. CO light-off curve 704 shows CO conversion for a fresh stoichiometric Cu—Mn spinel of Example #2 prepared by templating method 200, SM2-Type 1. CO light-off curve 706 shows CO conversion for a fresh non-stoichiometric Cu—Mn spinel of Example #3 prepared by templating method 200, SM3-Type 1. ZrO₂—Nb₂O₅ is used as support oxide for all samples. SM1-Type 1 may show better CO conversion response. Stoichiometric and non-stoichiometric Cu—Mn spinels, SM2-Type 1 and SM3-Type 1, show similar response to CO conversion under rich condition. Fresh SM1-Type 1, SM2-Type 1, and SM3-Type 1 shows T50 of CO at 185° C., 219° C. and 215° C., respectively.

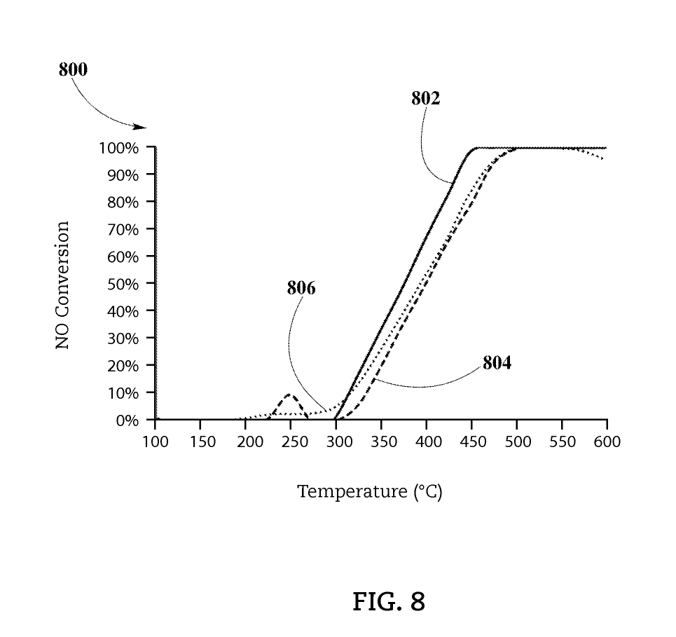

FIG. 8 illustrates performance in NO light-off 800 of Cu—Mn ZPGM powder catalysts prepared by different synthesis methods on ZrO₂—Nb₂O₅ support. NO light-off curve 802 shows NO conversion for a fresh stoichiometric Cu—Mn spinel of Example #1 prepared by co-precipitation method, SM1-Type 1. NO light-off curve 804 shows NO conversion for a fresh stoichiometric Cu—Mn spinel of Example #2 prepared by templating method 200, SM2-Type 1. NO light-off curve 806 shows CO conversion for a fresh non-stoichiometric Cu—Mn spinel of Example #3 prepared by templating method 200, SM3-Type 1. ZrO₂—Nb₂O₅ is used as support oxide for all samples. SM1-Type 1 may show better NO conversion response. Stoichiometric and non-stoichiometric Cu—Mn spinels, SM2-Type 1 and SM3-Type 1, show approximately similar response to NO conversion, especially at temperature above 400° C. Fresh SM1-Type 1, SM2-Type 1, and SM3-Type 1 shows T50 of NO at 375° C., 397° C. and 393° C., respectively.

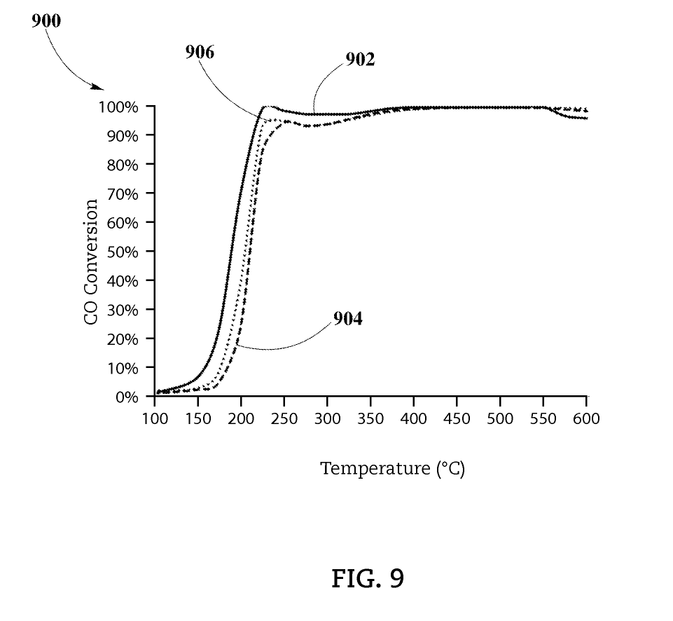

FIG. 9 illustrates CO light-off 900 of Cu—Mn ZPGM powder catalysts prepared by different synthesis methods on praseodymium doped ZrO₂ support. CO light-off curve 902 shows CO conversion for a fresh stoichiometric Cu—Mn spinel of Example #1 prepared by co-precipitation method, SM1-Type 2. CO light-off curve 904 shows CO conversion for a fresh stoichiometric Cu—Mn spinel of Example #2 prepared by templating method 200, SM2-Type 2. CO light-off curve 906 shows CO conversion for a fresh non-stoichiometric Cu—Mn spinel of Example #3 prepared by templating method 200, SM3-Type 2. ZrO₂—Pr₆O₁₁ is used as support oxide for all samples. SM1-Type 2 may show better CO conversion response under rich condition. Fresh SM1-Type 2, SM2-Type 2, and SM3-Type 2 shows T50 of CO at 187° C., 210° C. and 203° C., respectively.

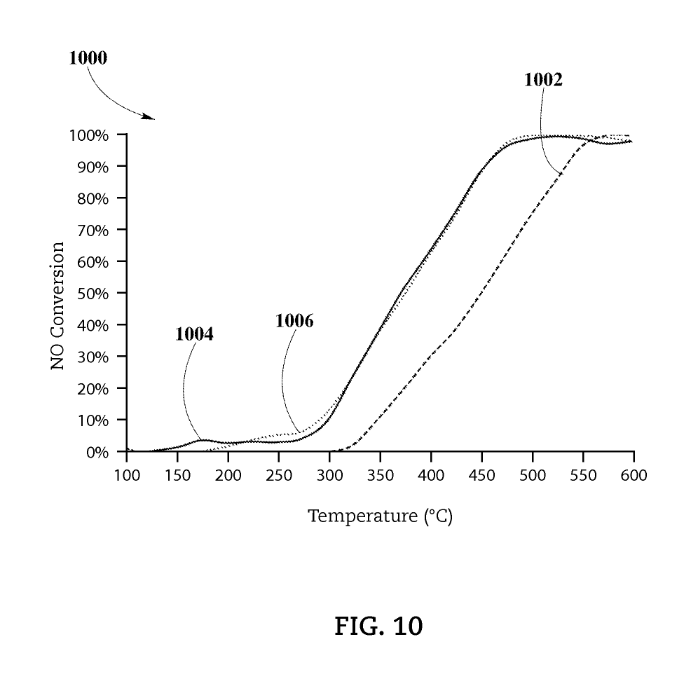

FIG. 10 illustrates performance in NO light-off 1000 of Cu—Mn ZPGM powder catalysts prepared by different synthesis methods on praseodymium doped ZrO₂ support. NO light-off curve 1002 shows NO conversion for a fresh stoichiometric Cu—Mn spinel of Example #1 prepared by co-precipitation method, SM1-Type 2. NO light-off curve 1004 shows NO conversion for a fresh stoichiometric Cu—Mn spinel of Example #2 prepared by templating method 200, SM2-Type 2. NO light-off curve 1006 shows CO conversion for a fresh non-stoichiometric Cu—Mn spinel of Example #3 prepared by templating method 200, SM3-Type 2. ZrO₂—Pr₆O₁₁ is used as support oxide for all samples. SM1-Type 2 may show lower NO conversion response. Stoichiometric and non-stoichiometric Cu—Mn spinels, SM2-Type 2 and SM3-Type 2, shows approximately similar response to NO conversion and significant improvement compare to SM1-Type 2. Fresh SM1-Type 2, SM2-Type 2, and SM3-Type 2 show T50 of NO at 450, 370 and 375 C, respectively. The formation of Cu—Mn spinel in fresh SM2-Type 2, and SM3-Type 2 is responsible for NO conversion improvement compare to mixed Cu and Mn oxide phase in fresh SM1-Type2.

While various aspects and embodiments have been disclosed, other aspects and embodiments may be contemplated. The various aspects and embodiments disclosed here are for purposes of illustration and are not intended to be limiting, with the true scope and spirit being indicated by the following claims.

What is claimed is:

1. A catalyst system, comprising:
a substrate;
a washcoat suitable for deposition on the substrate, comprising at least one oxide solid;
an impregnation layer, comprising at least one first catalyst; and
an overcoat suitable for deposition on the substrate, comprising at least one overcoat oxide solid selected from the group consisting of at least one of a carrier material oxide and at least one second catalyst;
wherein the at least one first catalyst comprises at least one spinel structured compound having the formula AB₂O₄, wherein each of A and B is selected from the group consisting of at least one of copper and manganese; and
wherein the at least one spinel structured compound is in mixed phase with at least one metal oxide.

2. The catalyst system of claim 1, wherein a portion of the at least one spinel structured compound is non-stoichiometric.

3. The catalyst system of claim 2, wherein the at least one spinel structured compound is synthesized by a method selected from the group consisting of co-precipitation, impregnation, co-miling, templating, colloidal, organometallic, sol-gel, and combinations thereof.

4. The catalyst system of claim 1, wherein a portion of the at least one spinel structured compound is stoichiometric.

5. The catalyst system of claim 4, wherein the at least one spinel structured compound is synthesized by a method selected from the group consisting of co-precipitation, impregnation, co-miling, templating, colloidal, organometallic, sol-gel, and combinations thereof.

6. The catalyst system of claim 1, wherein the at least one metal oxide is selected from the group consisting of copper oxide, manganese oxide, and combinations thereof.

7. The catalyst system of claim 1, wherein the washcoat further comprises at least one third catalyst.

8. The catalyst system of claim 7, wherein the at least one third catalyst comprises at least one selected form the group consisting of copper, manganese, and combinations thereof.

9. The catalyst system of claim 1, wherein the at least one spinel structured compound has a Cu/(Cu—Mn) molar ratio of about 0.10.

10. The catalyst system of claim 1, wherein the at least one spinel structured compound has a Cu/(Cu—Mn) molar ratio of about 0.90.

11. The catalyst system of claim 1, wherein the at least one spinel structured compound improves an NO conversion rate compared to an at least one non-spinel structured compound.

12. The catalyst of claim 1, wherein the at least one carrier metal oxide is selected from the group consisting of cerium oxide, alumina, lanthanum doped alumina, titanium oxide, zirconia, ceria-zirconia, Nb₂O₅—ZrO₂, and combinations thereof.

13. The catalyst system of claim 1, wherein the washcoat further comprises at least one oxygen storage material selected from the group consisting of cerium oxide, zirconium oxide, lanthanum oxide, yttrium oxide, lanthanide oxides, actinide oxides, and combinations thereof.

14. The catalyst system of claim 1, wherein the overcoat further comprises at least one oxygen storage material selected from the group consisting of cerium oxide, zirconium oxide, lanthanum oxide, yttrium oxide, lanthanide oxides, actinide oxides, and combinations thereof.

15. The catalyst system of claim 1, wherein the at least one first catalyst is prepared by a method selected from the group consisting of co-milling, co-precipitation, impregnation, stabilization, templating, and the sol-gel method.

16. The catalyst system of claim 1, wherein the at least one first catalyst is prepared by co-precipitation and wherein the ratio of stoichiometric to non-stoichiometric portions of the at least one spinel structured compound is effected by use of one selected from the group consisting of the metal precursor, type of precipitant agent, pH of slurry, aging time, Cu/Mn ratio, type of carrier metal oxide, and combinations thereof.

17. The catalyst system of claim 1, wherein the at least one first catalyst is prepared by templating and wherein the ratio of stoichiometric to non-stoichiometric portions of the at least one spinel structured compound is effected by the use of one selected from the group consisting of the metal precursor, type of precipitant agent, pH of slurry, aging time, Cu/Mn ratio, type of carrier metal oxide, and combinations thereof.

18. The catalyst system of claim 1, wherein the size of the at least one first catalyst is less than about 9 nm.

19. The catalyst system of claim 1, wherein the size of the at least one first catalyst is less than about 14 nm.
